(19) United States
(12) Patent Application Publication
(10) Pub. No.: US 2014/0006063 A1
(43) Pub. Date: Jan. 2, 2014

(54) Method for Efficient Processing of Insurance Claims

(71) Applicants: William J. Durel, Lafayette, LA (US); Douglas Thomas, Cincinnati, OH (US); Steven D. Thomas, Cincinnati, OH (US)

(72) Inventors: William J. Durel, Lafayette, LA (US); Douglas Thomas, Cincinnati, OH (US); Steven D. Thomas, Cincinnati, OH (US)

(21) Appl. No.: 13/931,892

(22) Filed: Jun. 29, 2013

Related U.S. Application Data
(60) Provisional application No. 61/665,983, filed on Jun. 29, 2012.

(51) Int. Cl. G06Q 40/08

(52) U.S. Cl. CPC G06Q 40/08
USPC 705/4; 382/100; 345/443

(57) ABSTRACT

Rooms, structures and objects can be accurately diagrammed, often without performing a physical on-site inspection. Photograph(s) of a room, structure or object are uploaded to a computer having a processor. A base calibration measure is determined for a room, structure, object, or component thereof, depicted in the photograph(s) using at least one known dimension for item(s) observable in the photograph(s). The base calibration measure is then used to determine dimensions of other areas, items or objects depicted in such photograph(s), and to create at least one scale diagram of the subject matter of the photograph(s). The scale diagram(s) can then be used to calculate appropriate insurance payment amount(s).

### CROSS REFERENCES TO RELATED APPLICATION

PRIORITY OF U.S. PROVISIONAL PATENT APPLICATION Ser. No. 61/665,983, FILED Jun. 29, 2012, INCORPORATED HEREIN BY REFERENCE, IS HEREBY CLAIMED.

### STATEMENTS AS TO THE RIGHTS TO THE INVENTION MADE UNDER FEDERALLY SPONSORED RESEARCH AND DEVELOPMENT

NONE

### BACKGROUND OF THE INVENTION

1. Field of the Invention

The present invention pertains to a method for generating scale diagram(s) of an area, structure, or object using photographs. More particularly, the present invention pertains to a method for using scale diagram(s) generated from photographs to efficiently process loss claims including, without limitation, casualty insurance claims.

2. Brief Description of the Prior Art

Many insured property damage claims require a physical inspection by at least one adjuster. Such adjusters, who are frequently employees or contractors of an insurance provider, physically inspect insured property in order to assess damages and process applicable insurance claims. Many insurance providers have so-called “fast track” claims which allow for processing of property damage claims without conducting on-site inspections. However, such fast track claims are typically processed without significant information regarding the property at issue, as well as the nature and extent of the alleged damages. As a result, such existing fast track claims are typically highly vulnerable to inaccuracies and/or inequities in the claims adjustment process. Moreover, such fast track claims currently represent a fairly small percentage of property damage insurance claims.

Every on-site inspection has inherent costs, whether such inspection is performed by an insurance company employee or a third-party contractor. Such costs can include direct expenses, such as adjustor salaries or contractor fees. However, such inspection costs can also include other expenses, such as vehicle, fuel, maintenance, vacation and benefit costs, as well as workers compensation insurance. Physical inspections also expose company and contract adjustors to a risk of personal injury or death, particularly at property locations that have suffered significant damage.

Physical inspections, which are also time consuming and labor intensive, can also substantially delay the claim adjusting process. Such delay is especially common during times of higher claims volume, such as following extreme weather events or natural disasters when multiple property locations are damaged or destroyed. This delay can have a detrimental effect on customer service and customer satisfaction.

Thus, there is a need for an improved means for processing property loss/casualty claims that increases efficiency and lowers costs. The method should provide information to allow an insurer to determine whether an on-site physical inspection is required. In cases where such physical inspection is not required, the improved means for processing property loss/casualty claims should permit generation of scale diagram(s) of an area, structure, or object using photographs, as well as the use of such scale diagram(s) in connection with the claim processing procedure.

### SUMMARY OF THE INVENTION

The method of the present invention significantly increases the number of “fast track” loss/casualty claims (while reducing costs associated with inspection claims), while maintaining the integrity of the claim adjusting process. Furthermore, the present invention can substantially speed up the claims adjusting process, while improving customer service, customer involvement and overall satisfaction. Additionally, the present invention can be used by both inside and field adjusters.

The present invention allows inside adjusters to accurately diagram rooms, structures and objects without performing a physical on-site inspection by using photographs, including photographs submitted via email or over the internet. Such photographs can be provided by a property owner (or other source) and used by an inside adjustor to process a claim without the need for physically inspecting a location.

Even when on-site inspection is required, the present invention allows field adjusters to expedite the inspection process by eliminating the need for diagramming a property while actually on location, thereby allowing an adjustor to inspect more properties during a given time period. Such efficiency is particularly important during times of higher claims volume, such as following extreme weather or natural disasters when multiple property locations are damaged or destroyed by a common event. The present invention also improves safety by reducing the amount of time that a field adjustor is required to remain on-site at a damaged location.

In accordance with the present invention, photographs of a damaged property are initially obtained. Where possible, such photographs can be taken by a property owner or other person acting on behalf of said property owner. However, it is to be observed that in certain circumstances, an adjustor or other inspector may be required to travel to a location in order to obtain such photographs.

Once obtained, such photographs can be sent to a claim processing facility, whether by physical delivery, electronic mail, internet submission or other means. In many cases, such photographs are organized by room, structure or object in question. Such photographs are then uploaded to a computer having a processor; when only printed copies of photographs are provided, such photographs can be scanned or otherwise digitized in order to facilitate such uploading process.

After such photograph(s) have been uploaded to a computer having a processor, a base calibration measure is obtained for a particular room, structure, object or component thereof depicted in such photograph(s) using at least one known dimension for item(s) observable in such photograph(s). Although such known dimensions can be obtained from any number of different sources, in the preferred embodiment said known dimensions are obtained from standards existing for particular items. By way of illustration, but not limitation, such standard dimensions can be obtained from building codes (or other rules or regulations established by applicable governmental or regulatory agencies), manufacturer specifications, or other sources. For example, such standard dimensions can include, without limitation, door heights, bricks, kitchen sinks, furniture items and the like.

After said base calibration measure has been determined using said at least one known dimension, said base calibration measure can then be used to determine dimensions of other areas, items or objects depicted in such photograph(s). Thereafter, said dimensions can be utilized to create at least one scale diagram of a room, area, structure or object in question. In additional to diagramming a room, areas, structure or object, visible or known damaged areas, surfaces and/or materials can be measured in order to determine the extent of repairs or replacement required.

Such scale diagram(s) can then be used to calculate an appropriate insurance payment amount. Frequently, such scale diagram(s) can be uploaded into conventional estimating computer software commonly used to calculate insurance payments well known to those having skill in the art of adjusting property damage claims. By way of example, such conventional estimating software can include, without limitation, commercially available estimating software marketed under the trademarks “Xactimate” or “Symbility”, or such other software as may provide desired output information. Where applicable, deductions for openings (windows, doors, missing walls) and other features associated with said rooms, structures or other objects depicted in such scale diagram(s) can be taken into account when calculating such insurance payment.

Although the present invention is described herein primarily in connection with the processing of insurance claims, it is to be observed that the present invention has utility in a wide range of other applications and/or industries. For example, the present invention can benefit non-insurance applications including, without limitation, real estate, interior design, remodeling/reconstruction, security and other industries that require or can utilize scale diagrams of areas, structures or other objects.

### BRIEF DESCRIPTION OF DRAWINGS/FIGURES

The foregoing summary, as well as any detailed description of the preferred embodiments, is better understood when read in conjunction with the drawings and figures contained herein. For the purpose of illustrating the invention, the drawings and figures show certain preferred embodiments. It is understood, however, that the invention is not limited to the specific methods and devices disclosed in such drawings or figures.

FIG. 1 depicts a digital image of a photograph showing a perspective view of an internal space of a structure that can be diagrammed using the method of the present invention.

FIG. 2 depicts a digital image of a photograph showing an alternate perspective view of the internal space of a structure depicted in FIG. 1.

FIG. 3 depicts a digital image of a photograph showing a perspective view of a first portion of an internal space of a structure that can be diagrammed using the method of the present invention.

FIG. 4 depicts a digital image of a photograph of a perspective view of a second portion of an internal space of a structure depicted in FIG. 3.

### DETAILED DESCRIPTION OF A PREFERRED EMBODIMENT

Upon notice of the existence of a claim to be processed, an initial determination is made regarding whether an on-site inspection is required. If so, then an inspector can be dispatched to the location of the property at issue. If not, then the claim can be classified as a so-called “fast track” claim and handled accordingly.

In accordance with the present invention, photographs of a damaged property are initially obtained. For “fast track” claims, specific instructions can be provided to a claimant, property owner, tenant or other interested party regarding certain actions to be taken including, without limitation, instructions regarding how to photograph the property at issue, label such photographs, and submit such photographs for further handling. In many case, such photographs (whether digital photos, or scanned or digitized images) can be sent by electronic mail or uploaded to a web site or other portal accessible via the Internet.

When physical inspection is performed, a field adjuster or inspector can visit the property that is the subject of the claim. Said field adjustor or inspector can then photograph the property that is subject to the claims (frequently pursuant to a method that is similar to the instructions provided to claimants, property owners, tenants or other interested parties using “fast track” claim processing). Said field adjuster or inspector can also takes notes on damages or other observed conditions (commonly referred to in the insurance industry as a “tic sheet”) and/or gather such other information from the location as deemed advisable under the circumstances.

Regardless of how obtained (whether from an inspector or adjuster, or from a claimant, property owner or tenant) such photographs are uploaded or otherwise imported to a computer having a processor. Such photographs can be beneficially organized by room, structure or object in question, or other desirable classification scheme.

After such photograph(s) have been uploaded or otherwise imported to a computer having a processor, one or more digital images can be displayed via a computer monitor or other graphic interface. In the preferred embodiment, said digital image(s) depict substantially the same view as said photograph(s); however, it is to be observed that said digital images can be zoomed, enhanced or otherwise digitally manipulated using means well known to those having skill in the art. A base calibration measure is obtained for each particular room, structure, object or component thereof depicted in such photograph(s) using at least one known dimension for item(s) observable in such photograph(s).

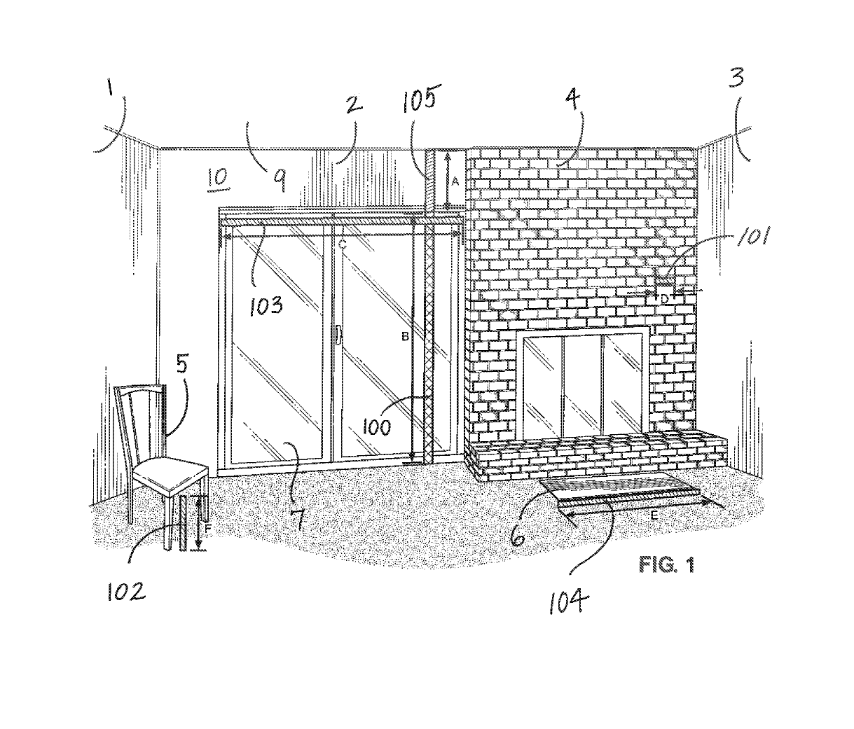

Referring to the drawings, FIG. 1 depicts digital image of a photograph of a perspective view of an internal space of a structure 10 that can be diagrammed using the method of the present invention. As depicted in FIG. 1, structure 10 generally comprises walls 1, 2 and 3, and ceiling 9. Said structure further includes a brick hearth and fireplace 4, chair 5, rug 6 and doorway 7.

A base calibration measure is generated by digitally (graphically) drawing a line on said digital image using a computer and software of the present invention. By way of illustration, and as depicted in FIG. 1, line 100 can be graphically drawn from the floor at the bottom of doorway 7 to the top of doorway 7. Said line 100 is assigned a length dimension—depicted as dimension “B” on FIG. 1—based upon a known standard of the height of doorway 7. For example, said calibration line 100 can be assigned a length dimension of 6′8″ (based on standard doorway height as set forth in an applicable local building code), with digital calibration line 100 being scaled accordingly.

Although such known dimensions can be obtained from any number of different sources, in the preferred embodiment said known dimensions are obtained from standards existing for particular items. By way of illustration, but not limitation, such standard dimensions can be obtained from building codes (or other rules or regulations established by applicable governmental or regulatory agencies), manufacturer specifications, or other sources. For example, such standard dimensions can include, without limitation, door heights, bricks, kitchen sinks, furniture items and the like. In the preferred embodiment, database(s) can be created for such known standards, which standards can be obtained from a variety of sources.

Still referring to FIG. 1, said base calibration dimension B (and the associated scale of line 100) can be confirmed using other known standards observable within said digital image of said photograph. For example, line 101 can be graphically drawn on said digital image to correspond to the width of a brick in hearth/fireplace 4 and assigned dimension “D” (for example, 7½″). Similarly, lines can be graphically drawn on said digital image to correspond to other known dimensions, such as line 102 representing the height of chair 5 (dimension “F”), line 103 representing the width of doorway 7 (dimension “C”) and line 104 representing the width of rug 6 (dimension “E”). In this manner, base calibration dimension B can be confirmed by comparison to said other known dimensions C, D, E and F, and adjusted if required, based on such other dimensions (or other known dimensions measured from said image) to represent the most accurate base calibration dimension B and applicable scale for line 100.

Base calibration line 100 having dimension B is fixed for use with said image, with said dimension B being displayed on said digital image depicted in FIG. 1. After line 100 is fixed in length, it can be graphically moved, turned and/or otherwise repositioned on such image, as desired, in order to determine the dimensions of other unknown items in FIG. 1. For example, calibration line 100 can be graphically placed in a desired position, such as the opening of doorway 7 on FIG. 1. A first end of said line 100 can be graphically anchored on the floor at the base of doorway 7, while the second end of said line 100 can be “stretched” to the intersection of wall 2 and ceiling 9, thereby forming a stretch line 105 having dimension “A”. In the preferred embodiment, line 100 does not change in length; rather, stretch line 105 is displayed as a different color extending from the second end of calibration line 100 in order to graphically represent the additional length of line 105 (and dimension A) relative to line 100 (and dimension B).

Dimension A can be determined using the length of line 105 and the scale established by said base calibration line 100 and known dimension B. Thereafter, the height of said wall 2 (that is, the distance from the floor to the intersection of wall 2 and ceiling 9) can be determined as the sum of dimensions A and B. Similarly, other unknown dimensions can be calculated from said photographic image in substantially the same manner using said base calibration line 100 and dimension B. Specifically, line 100 can be graphically moved, turned and/or otherwise repositioned on such image (and then anchored, and stretched/compressed), to determine other unknown dimensions depicted on said photographic image.

In the preferred embodiment, when an item or object larger than dimension B is being measured on the image of FIG. 1, a stretch line is displayed as a different color extending from the non-anchored end of calibration line 100 in order to graphically represent the additional or incremental length of said stretch line relative to said calibration line 100. Conversely, when an item or object smaller than line 100 or dimension B is being measured on the image of FIG. 1, a parallel “subtraction line” is graphically displayed adjacent to said calibration line in a different color than line 100; said subtraction line graphically represents the reduction in length of the measured item/object compared to the original length of calibration line 100.

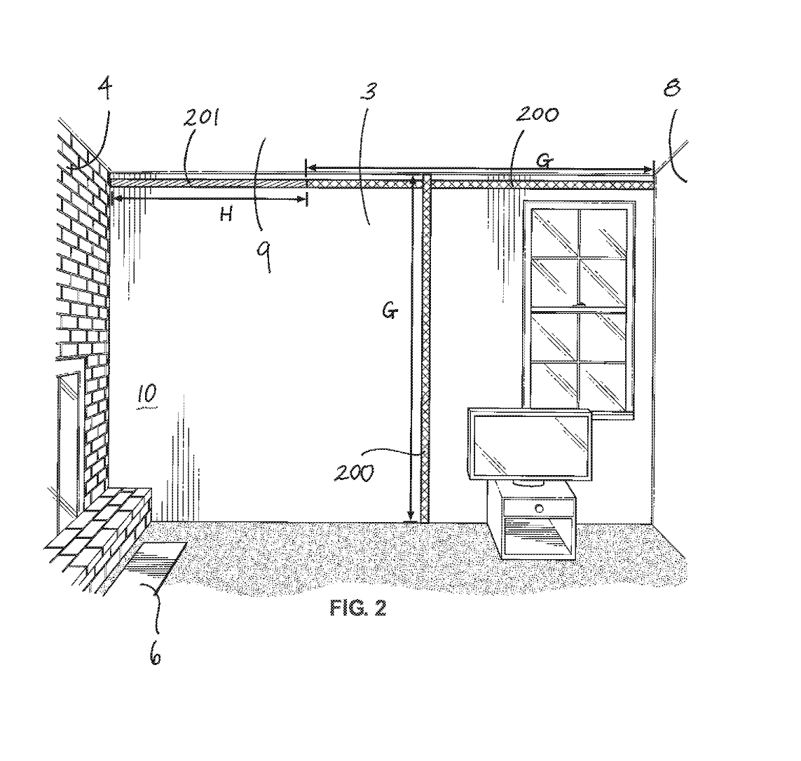

FIG. 2 depicts a digital image of an alternate perspective view of the internal space of a structure 10 depicted in FIG. 1 including, without limitation, wall 3, ceiling 9, rug 6 and hearth/fireplace 4. Put another way, FIG. 2 depicts another perspective of a different portion of a room depicted in FIG. 1. In FIG. 2, a new base calibration line 200 having a known distance is established on FIG. 2. Because the distance from floor to ceiling in the subject room was determined in FIG. 1 (as the sum of dimensions A and B), one end of new calibration line 200 can be anchored on the floor at the base of wall 3, while the other end of said line 200 can be stretched to the intersection of wall 3 and ceiling 9; this new calibration line 200 can then be assigned a known dimension “G” (equivalent to the sum of dimensions A and B determined in FIG. 1).

As with FIG. 1, fixed-length calibration line 200 having a base calibration dimension G can then be graphically moved, turned and/or otherwise repositioned (and then anchored, and stretched/compressed) on FIG. 2 to determine other unknown dimensions depicted on said photographic image. When an item or object larger than dimension G is being measured on the image of FIG. 2, a stretch line can be displayed as a different color extending from the non-anchored end of calibration line 200 in order to graphically represent the additional or incremental length of said stretch line relative to said calibration line 200. Conversely, when an item or object smaller than line 200 or dimension G is being measured on the image of FIG. 2, a parallel “subtraction line” is graphically displayed adjacent to said calibration line 200 in a different color than line 200; said subtraction line graphically represents the reduction in length of the smaller measured item/object compared to the original length of calibration line 200.

For example, a first end of said calibration line 200 can be graphically anchored at the intersection between walls 3 and 8, while the second end of said calibration line 200 can be graphically “stretched” to the intersection of wall 3 and hearth/fireplace 4, thereby forming a stretch line 201 having dimension “H”. In the preferred embodiment, calibration line 200 does not change in length; rather, stretch line 201 is displayed as a different color extending from the second end of calibration line 200 in order to graphically represent the additional length of line 201 (and dimension H) relative to fixed calibration line 200 (and dimension G).

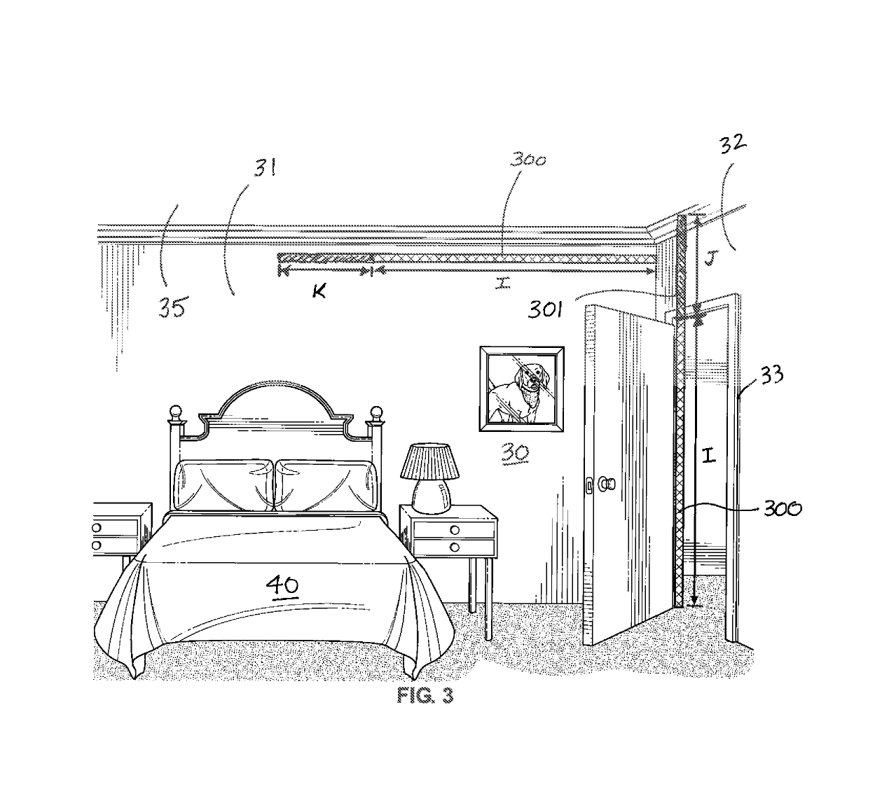

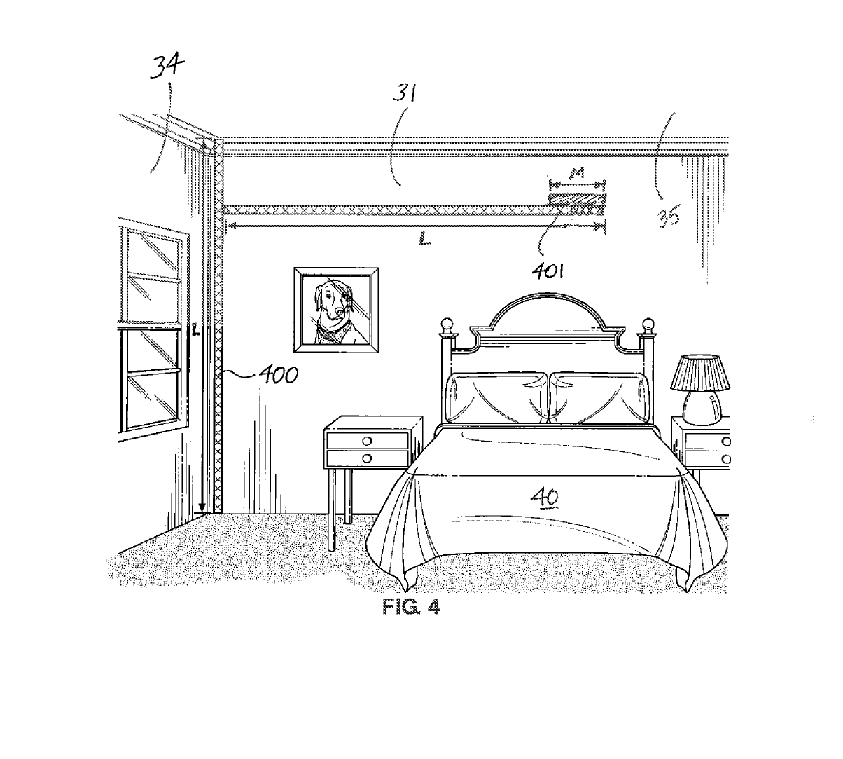

On occasion, it may be necessary to utilize more than one photograph of the same basic area, structure or object due to the size of walls, structures or other objects being diagrammed. FIG. 3 depicts a digital image depicting a perspective view of a first portion of an internal space of a structure 30 having walls 31 and 32, door opening 33 formed in wall 32, ceiling 35 and bed 40. FIG. 4 depicts a digital image showing a perspective view of a second portion of said internal space of structure 30 depicted in FIG. 3; from the perspective of FIG. 4, structure 30 has walls 31 and 34, ceiling 35 and bed 40. It is to be observed that there is some overlap between the subject matter depicted in FIGS. 3 and 4.

A base calibration measure is generated for FIG. 3 by digitally (graphically) drawing a line on said digital image using a computer and software of the present invention. By way of illustration, and as depicted in FIG. 3, line 300 can be graphically drawn from the floor at the bottom of door opening 33 to the top of said door opening 33. Said line 300 is assigned a length dimension—depicted as dimension “I” on FIG. 3—based upon a known standard of the height of door opening 33 as described previously. For example, said calibration line 300 can be assigned a length dimension of 6′8″, with digital calibration line 300 being scaled accordingly.

Base calibration line 300 having dimension I is fixed for use with said image, with said dimension I being displayed on said digital image depicted in FIG. 3. After calibration line 300 is fixed in length, it can be graphically moved, turned and/or otherwise repositioned on such image, as desired, in order to determine the dimensions of other unknown items in FIG. 3. For example, a first end of said calibration line 300 can be graphically anchored on the floor at the base of door opening 33, while the second end of said line 300 can be “stretched” to the intersection of wall 32 and ceiling 35, thereby forming a stretch line 301 having dimension “J”. In the preferred embodiment, line 300 does not change in length; rather, stretch line 301 is displayed as a different color extending from the second (upper) end of calibration line 300 in order to graphically represent the additional length of line 301 (and dimension J) relative to line 300 (and dimension I).

Similarly, a first end of said calibration line 300 can be graphically anchored at the intersection of walls 31 and 32, while the second end of said line 300 can be “stretched” to a selected reference point (such as the center of bed 40), thereby forming a stretch line 302 having dimension “K”. In the preferred embodiment, line 300 does not change in length; rather, stretch line 302 is displayed as a different color extending from the non-anchored end of calibration line 300 in order to graphically represent the additional length of stretch line 302 (and dimension K) relative to line 300 (and dimension I).

In FIG. 4, a new base calibration line 400 having a known distance is established for FIG. 4. Because the distance from floor to ceiling in the subject room was determined in FIG. 3 (as the sum of dimensions I and J), one end of new calibration line 400 can be anchored on the floor at the base of wall 31, while the other end of said line 400 can be stretched to the intersection of wall 31 and ceiling 35; this new calibration line 400 can then be assigned a known dimension “L” (which equivalent to the sum of dimensions I and J as previously determined in FIG. 3).

As with the other figures, fixed-length calibration line 400 having a base calibration dimension I can then be graphically moved, turned and/or otherwise repositioned (and then anchored, and stretched/compressed) on FIG. 4 to determine other unknown dimensions depicted on said photographic image. For example, a first end of said calibration line 400 can be graphically anchored at the intersection between walls 31 and 34, while the second end of said calibration line 400 can be graphically moved to the previously determined reference point at the center of bed 40. Because the distance from wall 34 to said reference point (the center of bed 40) is less than dimension L of calibration line 400, subtraction line 401 graphically represents the differences in length between: (1) the distance from wall 34 to said reference point; and (2) the original length of calibration line 400.

Such linear dimensions determined in accordance herewith can then be used, on the applicable images, to determine areas (typically expressed as square footage) of doors, windows, missing walls and other areas (wainscoting) to be deducted. Additionally, unknown dimensions of other features such as, for example, wall coverings, paintings and/or other items, can also be calculated in this manner. Thereafter, said dimensions can be utilized to create at least one scale diagram of a room, structure or object in question.

Such scale diagram(s) can then be used to calculate appropriate insurance payment amount(s). Frequently, such scale diagram(s) can be uploaded into conventional estimating computer software commonly used to calculate insurance payments well known to those having skill in the art of adjusting property damage claims. By way of example, such conventional estimating software can include, without limitation, commercially available estimating software marketed under the trademarks “Xactimate” or “Symbility”, or such other software as may provide desired output information. Where applicable, deductions for openings (windows, doors, missing walls) and other features associated with said rooms, structures or other objects depicted in such scale diagram(s) can be taken into account when calculating such insurance payment.

In additional to diagramming rooms, areas, structures or objects, visible or known damaged areas, surfaces and/or materials can be measured in order to determine the extent of repairs or replacement required. Additionally, although the method and apparatus of the present invention contemplates the use of a computer having a processor and related software, it is to be observed that the method of the present invention can also be performed “by hand” using a scale ruler or other conventional measuring device following the basic process described above.

The above-described invention has a number of particular features that should preferably be employed in combination, although each is useful separately without departure from the scope of the invention. While the preferred embodiment of the present invention is shown and described herein, it will be understood that the invention may be embodied otherwise than herein specifically illustrated or described, and that certain changes in form and arrangement of parts and the specific manner of practicing the invention may be made within the underlying idea or principles of the invention.

What is claimed:

1. A method for diagramming at least one object comprising:
a) photographing said at least one object;
b) establishing a calibration scale from said photograph using at least one known dimension determined from said photograph;
c) measuring at least one other dimension from said photograph using said calibration scale; and
d) diagramming said at least one object using dimensions obtained from said photograph.

2. The method of claim 1, wherein said at least one known dimension is determined from a building code, rule or regulation.

3. The method of claim 1, wherein said at least one known dimension is determined from a manufacturer specification.

4. The method of claim 1, wherein said diagram is used to determine a monetary value for loss or damage to said at least one object.

5. The method of claim 4, wherein said monetary value is used to calculate an insurance payment amount.

6. The method of claim 5, further comprising using estimating software to determine said payment amount.

7. A method for diagramming a structure comprising:
a) photographing said structure;
b) graphically displaying said photograph using a computer having a processor;
c) establishing a calibration line having a scale on said displayed photograph using at least one known dimension determined from said displayed photograph;
d) measuring at least one other dimension from said photograph using said scale; and
e) diagramming said structure using said dimensions obtained from said photograph.

8. The method of claim 7, wherein said at least one known dimension is determined from a building code, rule or regulation.

9. The method of claim 7, wherein said at least one known dimension is determined from a manufacturer specification.

10. The method of claim 7, wherein said diagram is used to determine a monetary value for loss or damage to said at least one object.

11. The method of claim 10, wherein said monetary value is used to calculate an insurance payment amount.

12. The method of claim 11, further comprising using estimating software to determine said payment amount.

13. The method of claim 7, wherein said method further comprises:
a) graphically displaying a first photograph of a portion of said structure on a computer having a processor;
b) establishing a calibration line having a first scale on said displayed first photograph using at least one known dimension determined from said displayed first photograph;
c) measuring at least one other dimension from said first photograph using said first scale;
d) graphically displaying a second photograph of a portion of said structure on a computer having a processor;
e) establishing a second calibration line having a second scale on said second displayed photograph using at least one known dimension determined from said displayed second photograph; and
f) diagramming said structure using said dimensions obtained from said first and second photographs.

14. The method of claim 13, wherein said diagram is used to determine a monetary value for loss or damage to said structure.

15. The method of claim 14, wherein said monetary value is used to calculate an insurance payment amount.

16. The method of claim 15, further comprising using estimating software to determine said payment amount.
